(19) United States
(12) Patent Application Publication
(10) Pub. No.: US 2010/0115182 A1
(43) Pub. Date: May 6, 2010

(54) FLASH MEMORY OPERATION

(75) Inventor: Sivakumar Murugesan, San Diego, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignees: SONY CORPORATION, Tokyo (JP); SONY ELECTRONICS INC., Park Ridge, NJ (US)

(21) Appl. No.: 12/266,440

(22) Filed: Nov. 6, 2008

(51) Int. Cl. G06F 12/06

(52) U.S. Cl. 711/103; 711/159

(57) ABSTRACT

An embodiment is a technique to improve operations of flash memory devices. A plurality of logical block numbers is mapped to a plurality of physical block numbers using a mapper. The physical block numbers are associated with blocks in a flash memory device. A plurality of block statuses of the plurality of free physical block numbers is stored in a replacement table. Each of the block statuses is one of a ready, dirty, and broken status. A destination block in the blocks is written to. The destination block has the ready status. The mapper and the replacement table are updated.

### TECHNICAL FIELD

The presently disclosed embodiments are directed to the field of computer storage, and more specifically, to flash memory.

### BACKGROUND

Flash memory has been used increasingly as non-volatile memory in consumer electronics equipment. Applications of flash memory ranges from mobile phones, cameras, to television (TV) display. A flash memory device is typically organized in blocks. A block may be erased before writing.

Despite the popularity of flash memory as non-volatile storage, there are several inherent characteristics of flash memory devices that may lead to problems. First, the access granularity is limited by the block size. Each read or write access is performed within a block. Second, before a write access is performed on a block, the block has to be completely erased. Third, a block may sustain only a specified number of writes. These characteristics may lead to a number of problems. For example, the data may become inconsistent when power failure occurs during a write access. In addition, accesses to the flash memory device may be unevenly distributed causing stress to heavily used blocks.

### SUMMARY

One disclosed feature of the embodiments is a method and apparatus to improve operations of flash memory devices. A plurality of logical block numbers is mapped to a plurality of physical block numbers using a mapper. The physical block numbers are associated with blocks in a flash memory device. A plurality of block statuses of the plurality of physical block numbers is stored in a table. Each of the block statuses is one of a ready, dirty, and broken status. A destination block in the blocks is written to. The destination block has the ready status. The mapper and the table are updated.

### BRIEF DESCRIPTION OF THE DRAWINGS

Embodiments may best be understood by referring to the following description and accompanying drawings that are used to illustrate embodiments. In the drawings.

FIG. 1 is a diagram illustrating a system according to one embodiment.

FIG. 2 is a diagram illustrating a flash operation processor according to one embodiment.

FIG. 3 is a flowchart illustrating a process to perform flash operations according to one embodiment.

FIG. 4 is a flowchart illustrating a process to write to a destination block according to one embodiment.

### DETAILED DESCRIPTION

One disclosed feature of the embodiments is a technique to improve operations of flash memory devices. A plurality of logical block numbers is mapped to a plurality of physical block numbers using a mapper. The physical block numbers are associated with blocks in a flash memory device. A plurality of block statuses of the plurality of free physical block numbers is stored in a replacement table. Each of the block statuses is one of a ready, dirty, and broken status. A destination block in the blocks is written to. The destination block has the ready status. The mapper and the replacement table are updated.

In the following description, numerous specific details are set forth. However, it is understood that embodiments of the invention may be practiced without these specific details. In other instances, well-known circuits, structures, and techniques have not been shown to avoid obscuring the understanding of this description.

One disclosed feature of the embodiments may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc. One embodiment may be described by a schematic drawing depicting a physical structure. It is understood that the schematic drawing illustrates the basic concept and may not be scaled or depict the structure in exact proportions.

One disclosed feature of the embodiments is a technique to improve operations of flash memory devices, especially the write operation. The technique involves the use of house-keeping data to map a logical block number to a physical block number and to keep track of statuses of physical block numbers in a table.

In a prior art technique, a write operation performed on a block in a flash memory device includes reading that block, modifying the block contents, and writing the modified contents back to the block in the flash device. However, if a power failure occurs in the middle of the write operation, the block may be corrupted and after power is restored, the old information for that block may be corrupted or destroyed. The technique in an embodiment provides a way to keep the old data in the block during a write operation, even when power failure occurs during the write operation. The technique has a number of advantages. Some of the advantages include: (1) data consistency over power failure, (2) improved speed to writing to a block, (3) approximately uniform distribution of wear and tear for all blocks in the flash memory device, and (4) reduced number of replacements of free blocks needed.

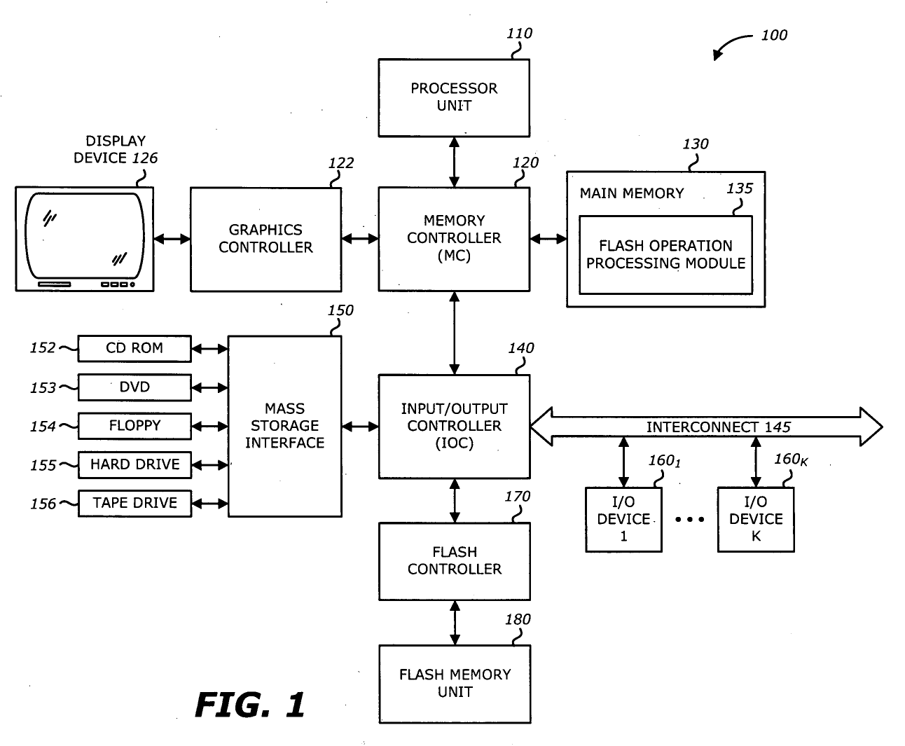

FIG. 1 is a diagram illustrating a system 100 according to one embodiment. The system 100 includes a processor unit 110, a memory controller (MC) 120, a graphics controller 122, a main memory 130, an input/output controller (IOC) 140, an interconnect 145, a mass storage interface 150, input/output (I/O) devices 160₁ to 160_{K}, a flash controller 170, and a flash memory unit 180. The system 100 may include more or less of the above components. The system 100 may be a stand-alone system or incorporated into other units, subsystems, or platforms. For example, the system 100 may be used as part of a set-top box, a television control unit, an integrated multimedia controller, etc.

The processor unit 110 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MC 120 provides control and configuration of memory and input/output devices such as the main memory 130 and the IOC 140. The MC 120 may be integrated into a chipset that integrates multiple functionalities such as graphics, media, host-to-peripheral bus interface, memory control, power management, etc.

The graphics controller 122 is any processor that provides graphics functionalities and to control display of graphics or video on a display device 126. The graphics controller 122 may also be integrated into the MC 120 to form a Graphics and Memory Controller (GMC). The graphics controller 122 may be a graphics card such as the Graphics Performance Accelerator (AGP) card, interfaced to the MC 120 via a graphics port such as the Accelerated Graphics Port (AGP) or a peripheral component interconnect (PCI) Express interconnect. The graphics controller 122 provides interface to an external display device such as standard progressive scan monitor, television (TV)-out device, and Transition Minimized Differential Signaling (TMDS) controller.

The display device 126 may be a television (TV) set, a display monitor, or a graphic output device. The display type may include any display type such as high definition TV (HDTV), cathode ray tube (CRT), flat panel display, plasma, liquid crystal display (LCD), etc.

The main memory 130 stores system code and data. The main memory 130 is typically implemented with dynamic random access memory (DRAM), static random access memory (SRAM), or any other types of memories including those that do not need to be refreshed. The main memory 130 may include multiple channels of memory devices such as DRAMs. The main memory 130 may contain a flash operation processing module 135 that performs the functions of improving operations of the flash memory devices in the flash memory unit 180.

The IOC 140 has a number of functionalities that are designed to support I/O functions. The IOC 140 may also be integrated into a chipset together or separate from the MC 120 to perform I/O functions. The IOC 140 may include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, wireless interconnect, direct media interface (DMI), etc.

The interconnect 145 provides interface to peripheral devices. The interconnect 145 may be point-to-point or connected to multiple devices. For clarity, not all interconnects are shown. It is contemplated that the interconnect 145 may include any interconnect or bus such as Peripheral Component Interconnect (PCI), PCI Express, Universal Serial Bus (USB), Small Computer System Interface (SCSI), serial SCSI, and Direct Media Interface (DMI), etc.

The mass storage interface 150 interfaces to mass storage devices to store archive information such as code, programs, files, data, and applications. The mass storage interface 150 may include SCSI, serial SCSI, Advanced Technology Attachment (ATA) (parallel and/or serial), Integrated Drive Electronics (IDE), enhanced IDE, ATA Packet Interface (ATAPI), etc. The mass storage device may include compact disk (CD) read-only memory (ROM) 152, digital video/versatile disc (DVD) 153, floppy drive 154, hard drive 155, tape drive 156, and any other magnetic or optic storage devices. The mass storage device provides a mechanism to read machine-accessible media.

The I/O devices 160₁ to 160_{K} may include any I/O devices to perform I/O functions. Examples of I/O devices 160₁ to 160_{K} include controller for input devices (e.g., keyboard, mouse, trackball, pointing device), media card (e.g., audio, video, graphic), and any other peripheral controllers.

The flash controller 170 may be a device that controls the operations and interface of the flash memory unit 180. The processor unit 110 may perform control functions such as error detection and correction, remapping bad blocks, read and write caching, providing file system interface, and data transfers. In one embodiment, the flash controller 170 may be included as part of the MC 120 or the IOC 140.

The flash memory unit 180 may be a circuit that includes a flash storage implemented by an array of NOR or NAND flash memory devices. The flash memory unit 180 may include memory drives in USB flash drives, multimedia media card, solid state drives, etc.

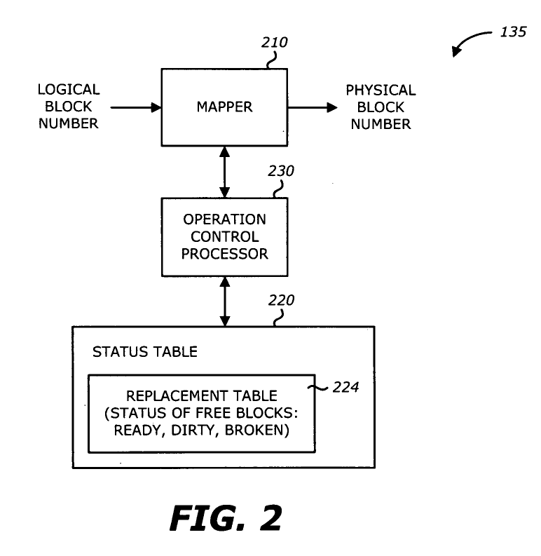

FIG. 2 is a diagram illustrating a flash operation processor 135 according to one embodiment. The flash operation processor 135 may be the processing module in the main memory 130, a separate module outside of the main memory 130, or a combination of modules that are internal and external to the main memory 130. In addition, the flash operation processor 135 may be implemented by hardware, software, firmware, or any combination of hardware, software, and firmware. The flash operation processor 135 includes a mapper 210, a status table 220, and an operation control processor 230.

The mapper 210 performs a mapping, look-up, or conversion function. It may map or convert a plurality of logical block numbers to a plurality of physical block numbers. The mapper 210 may be a map table or a circuit to perform mapping functions. If there are N logical blocks, then there are N entries. The mapper 210 maps a logical block number to a physical block number that is being in use. The physical block numbers are associated with blocks in a flash memory device in the flash memory unit 180 (FIG. 1). A physical block number (PBN) essentially indexes a block in the flash memory device. A block may include a number of pages (e.g., 32, 64, 128). A page may include a main area having a number of bytes (e.g., 512 bytes, 2048 bytes) and a spare area with a number of bytes (e.g., 16 bytes, 64 bytes). A logical block number (LBN) is used by software or the program code that accesses the flash device. Typically, programs that access data in the flash memory device know only the LBN to access the data, not the PBN. The mapper 210 may be stored in a spare area of flash memory device or a non-volatile memory.

The status table 220 includes a replacement table 224. The replacement table 224 has R entries. It lists the replacement or free blocks, each with one of the following status: ready, dirty, or broken. The ready status indicates that the block has been erased and is ready for writing. The dirty status indicates that the block is not erased yet and therefore is not ready for writing yet. The broken status indicates that the block is not usable, either because it cannot be erased, or there are errors during the erasure, or there are any other errors that render the block unusable. In one embodiment, the entries of the replacement table 224 are arranged in an ascending order with the least used ready block number being at the head; i.e., the head or the first entry contains the least used block number with a ready status. The table 220 may be stored in a spare area of flash memory device or a non-volatile memory.

The table 220 may be implemented by a data structure (e.g., linked list) that allows random insertion or re-arrangement so that entries may be easily accessible. For example, entries for the ready status may be located on top, or head, of the table, and entries for the dirty status may be located at the end, or bottom, of the table. The status of a block may be updated or changed as a result of a write operation of a block erasure. For example, when a block is successfully erased, its status may be changed to ready.

The operation control processor 230 provides control functionalities to facilitate the improved operations on the flash memory devices. It may include module (e.g., hardware circuit or software functions) that perform the operations, or enable the operations, as described in the following. For example, it may write, or enable writing, to a destination block using the procedure described below, update the mapper 210 and the table 220, maintain the table 220, read a block and store the data in a buffer, modify the buffer, modify an entry in the mapper or map table so that the current logical block number now maps to the destination PBN, etc.

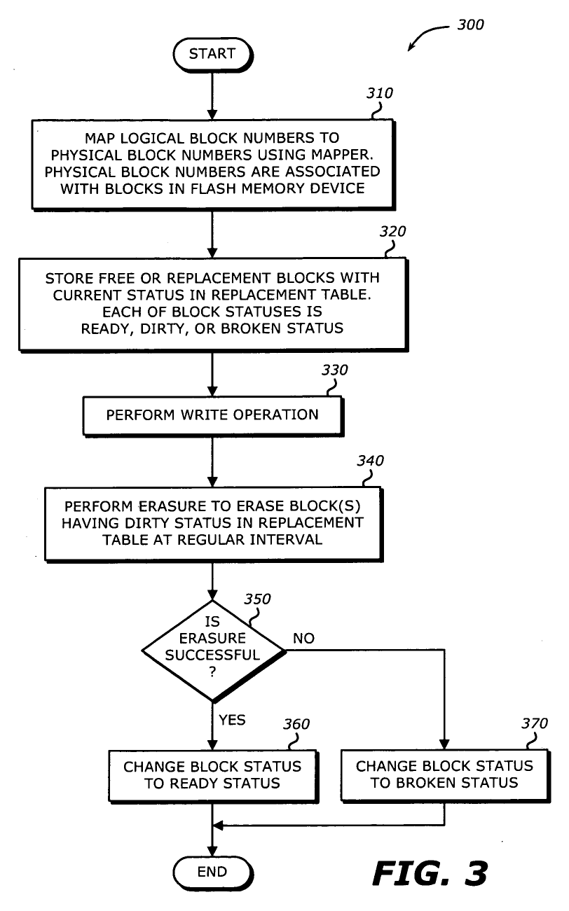

FIG. 3 is a flowchart illustrating a process 300 to perform flash operations according to one embodiment. Note that the operations performed in this process may be in any appropriate order.

Upon START, the process 300 maps a plurality of logical block numbers to a plurality of physical block numbers using a mapper (Block 310). The physical block numbers are associated with blocks in a flash memory device. Next, the process 300 stores a plurality of block statuses of the plurality of replacement or free physical block numbers in a replacement table (Block 320). Each of the replacement or free block statuses is one of a ready status, a dirty status, and a broken status.

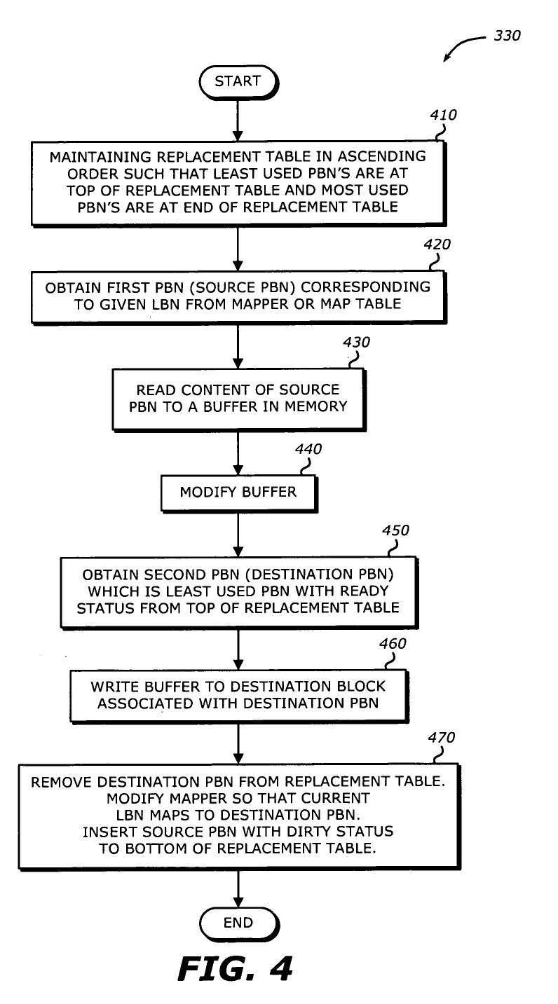

Then, the process 300 writes to a destination block in the blocks (Block 330). The destination block has the ready status. The destination block is a block in the flash memory device on which a write operation may be performed. The details of block 330 are shown in FIG. 4. Next, the process 300 performs an erasure at a regular interval, or when the device is not being accessed, to erase blocks that have dirty status in the replacement table (Block 340). By performing erasure of blocks that have dirty status in advance, or when the flash memory is not used, erased blocks may be available immediately for a writing operation; thus eliminating the need to erase a block before writing and leading to more efficient write operations. After each erasure, the process 300 determines if the erasure is successful (Block 350). If so, the process 300 changes the block status of the successfully erased block to the ready status and is then terminated. Otherwise, the process 300 changes the block status of the unsuccessfully erased block to the broken status and is then terminated.

FIG. 4 is a flowchart illustrating the process 330 shown in FIG. 3 to write to a block according to one embodiment. Note that the operations performed in this process may be in any appropriate order.

Upon START, the process 330 maintains the replacement table in an ascending order such that the least used physical block numbers are at the top of the replacement table and the most used physical block numbers are at the end of the replacement table (Block 410). This may be performed by maintaining a data structure that supports a random insertion (e.g., a linked list). This arrangement allows for an approximately even or uniform distribution of usage of the blocks to prevent excessive wear or stress on the blocks. This may lead to longer life of the blocks. The uniform distribution of usage also helps reducing the number of needed replacement blocks because the wear and tear are uniformly distributed to all blocks at any time making the wear-out period longer over the lifetime of the flash memory device.

Then, the process 330 obtains a first, or source, physical block number (PBN) corresponding to a given logical block number (LBN) from the mapper (Block 420). The given LBN is the LBN that a module or a program wants to access. Next, the process 330 reads the block associated with the first, or source, PBN to a buffer (Block 430). In other words, the process 330 transfers the contents of the block pointed to by, or corresponding to, the first, or source, PBN to the buffer. The buffer may be an allocated block of memory in the system, or a dedicated memory area reserved for storing temporary data from the block.

Then, the process 330 modifies the buffer (Block 440). This modification may involve changing one or more data variables in the buffer. Next, the process 330 obtains a second, or destination, PBN having the ready status from the head of the replacement table (Block 450). The second PBN is associated with the destination block.

Next, the process 330 writes the buffer to the destination block associated with the second, or destination, PBN (Block 460). Since the destination block has been kept erased by the periodic erasure process, this writing takes place without the need to erase the destination block. Accordingly, the writing operation is fast and efficient.

Then, the process 330 removes the second, or destination, PBN from the replacement table and adds the first, or source, PBN to the tail, or bottom, of the replacement table (Block 470). This operation involves one update to the map table, or the mapper, that maps the current LBN to the destination PBN, and one update to the replacement table (that removes the destination PBN and adds the source PBN with dirty status at the tail or bottom of the replacement table).

Note that the maintenance of the replacement table may be in any suitable order. The order may be any order as long as the rules of storing, retrieving, and updating are followed. For example, the order may be descending with the least used ready block number at the bottom or the tail and the most used block number at the top.

Elements of one embodiment may be implemented by hardware, firmware, software or any combination thereof. The term hardware generally refers to an element having a physical structure such as electronic, electromagnetic, optical, electro-optical, mechanical, electromechanical parts, etc. A hardware implementation may include analog or digital circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EPROM). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations. The program or code segments may be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that may store, transmit, receive, or transfer information. Examples of the processor readable or machine accessible medium that may store include a storage medium, an electronic circuit, a semiconductor memory device, a read only memory (ROM), a flash memory, an erasable programmable ROM (EPROM), a floppy diskette, a compact disk (CD) ROM, an optical disk, a hard disk, etc. Examples of the processor readable or machine accessible medium that may transmit, receive, or transfer information include a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include information or data that, when accessed by a machine, cause the machine to perform the operations or actions described above. The machine accessible medium may also include program code, instruction or instructions embedded therein. The program code may include machine readable code, instruction or instructions to perform the operations or actions described above. The term “information” or “data” here refers to any type of information that is encoded for machine-readable purposes. Therefore, it may include program, code, data, file, etc.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A method comprising:
mapping a plurality of logical block numbers to a plurality of physical block numbers using a mapper, the physical block numbers being associated with blocks in a flash memory device;
storing a plurality of block statuses of the plurality of free physical block numbers in a replacement table, each of the block statuses being one of a ready, dirty, and broken status;
writing to a destination block in the blocks, the destination block having the ready status; and
updating the mapper and the replacement table.

2. The method of claim 1 wherein writing to the destination block comprises:
obtaining a first physical block number (PBN) corresponding to a given logical block number from the mapper;
reading a block associated with the first PBN to a buffer;
modifying the buffer;
obtaining a second PBN having the ready status in the replacement table, the second PBN being associated with the destination block; and
writing the buffer to the destination block.

3. The method of claim 1 wherein updating the mapper and the table comprises:
changing an entry corresponding to the given logical block to the second physical block number in the mapper;
removing the second PBN from the replacement table; and
inserting the first PBN with a dirty status to end of the replacement table.

4. The method of claim 1 further comprising:
performing an erasure to erase replacement blocks corresponding to entries in the replacement table having the dirty status at a regular interval; and
if the erasure is successful, changing the block status to the ready status,
else changing the block status to the broken status.

5. The method of claim 2 further comprising:
maintaining the replacement table in an ascending order such that the least used physical block numbers are at the top of the replacement table and the most used physical block numbers are at the end of the replacement table.

6. The method of claim 5 wherein obtaining the second PBN having the ready status in the replacement table comprises:
obtaining the second PBN having the ready status from the top of the replacement table.

7. The method of claim 1 wherein at least one of the mapper and the replacement table is stored in a spare area of flash memory device or a non-volatile memory.

8. An article of manufacture comprising:
a machine-accessible storage medium including data that, when accessed by a machine, causes the machine to perform operations comprising:
mapping a plurality of logical block numbers to a plurality of physical block numbers using a mapper, the physical block numbers being associated with blocks in a flash memory device;
storing a plurality of block statuses of the plurality of free physical block numbers in a replacement table, each of the block statuses being one of a ready, dirty, and broken status;
writing to a destination block in the blocks, the destination block having the ready status; and
updating the mapper and the replacement table.

9. The article of manufacture of claim 8 wherein the data causing the machine to perform writing to the destination block comprise data that, when accessed by the machine, cause the machine to perform operations comprising:
obtaining a first physical block number (PBN) corresponding to a given logical block number from the mapper;
reading a block associated with the first PBN to a buffer;
modifying the buffer;
obtaining a second PBN having the ready status in the replacement table, the second PBN being associated with the destination block; and
writing the buffer to the destination block.

10. The article of manufacture of claim 8 wherein the data causing the machine to perform updating the mapper and the table comprise data that, when accessed by the machine, cause the machine to perform operations comprising:
changing an entry corresponding to the given logical block to the second physical block number in the mapper;
removing the second PBN from the replacement table; and
inserting the first PBN with a dirty status to end of the replacement table.

11. The article of manufacture of claim 8 wherein the data further comprise data that, when accessed by the machine, cause the machine to perform operations comprising:
performing an erasure to erase replacement blocks corresponding to entries in the replacement table having the dirty status at a regular interval; and
if the erasure is successful, changing the block status to the ready status,
else changing the block status to the broken status.

12. The article of manufacture of claim 9 wherein the data further comprise data that, when accessed by the machine, cause the machine to perform operations comprising:
maintaining the replacement table in an ascending order such that the least used physical block numbers are at the top of the replacement table and the most used physical block numbers are at the end of the replacement table.

13. The article of manufacture of claim 12 wherein the data causing the machine to perform obtaining the second PBN having the ready status in the replacement table comprise data that, when accessed by the machine, cause the machine to perform operations comprising:
obtaining the second PBN having the ready status from the top of the replacement table.

14. The article of manufacture of claim 8 wherein at least one of the mapper and the replacement table is stored in a spare area of flash memory device or a non-volatile memory.

15. A system comprising:
a flash controller;
a flash memory unit coupled to the flash controller, the flash memory unit having at least a flash memory device; and
a flash operation processing module, comprising:
a mapper to map a plurality of logical block numbers to a plurality of physical block numbers, the physical block numbers being associated with blocks in the at least flash memory device,
a replacement table to store a plurality of block statuses of the plurality of free physical block numbers, each of the block statuses being one of a ready, dirty, and broken status, and
an operation control processor coupled to the mapper and the replacement table to enable writing to a destination block in the blocks, the destination block having the ready status; wherein the mapper and the replacement table are updated after the destination block is written.

16. The system of claim 15 wherein the operation control processor reads a block associated with a first physical block number (PBN) to a buffer, the first PBN being provided by the mapper and corresponding to a given logical block number.

17. The system of claim 16 wherein the operation control processor modifies the buffer and obtains a second PBN having the ready status from the replacement table, the second PBN being associated with the destination block.

18. The system of claim 17 wherein the operation control processor writes the buffer to the destination block and removes the second PBN from the replacement table and an entry in the mapper is modified so that current LBN maps to the second PBN.

19. The system of claim 15 wherein the replacement table is maintained in an ascending order such that the least used physical block numbers are at the top of the replacement table and the most used physical block numbers are at the end of the replacement table.

20. The system of claim 15 wherein at least one of the mapper and the replacement table is stored in a spare area of flash memory device or a non-volatile memory.
